(19) United States
(12) Patent Application Publication
(10) Pub. No.: US 2018/0074506 A1
(43) Pub. Date: Mar. 15, 2018

(54) SYSTEMS AND METHODS FOR MAPPING ROADWAY-INTERFERING OBJECTS IN AUTONOMOUS VEHICLES

(71) Applicant: GM GLOBAL TECHNOLOGY OPERATIONS LLC, Detroit, MI (US)

(72) Inventor: ELLIOT BRANSON, SAN FRANCISCO, CA (US)

(73) Assignee: GM GLOBAL TECHNOLOGY OPERATIONS LLC, Detroit, MI (US)

(21) Appl. No.: 15/819,103

(22) Filed: Nov. 21, 2017

(51) Int. Cl. G05D 1/02; G05D 1/00; G08G 1/0967; G01S 17/89; G01S 7/48; G06N 3/04; G06N 3/08; G06K 9/20; G06T 17/05

(52) U.S. Cl. CPC G05D 1/0214; G05D 1/024; G05D 1/0088; G08G 1/096725; G01S 17/89; G01S 7/4808; G06T 7/00; G06N 3/08; G06K 9/2036; G06T 17/05; G05D 2201/0213; G06T 2210/21; G06N 3/04

(57) ABSTRACT

Systems and method are provided for controlling a vehicle. In one embodiment, a method of construction zone mapping method includes receiving sensor data relating to an environment associated with a vehicle, determining that a roadway-interfering object is present within the environment based on the sensor data, and generating a composite map including a representation of the roadway-interfering object superimposed upon a defined map of the environment.

### TECHNICAL FIELD

The present disclosure generally relates to autonomous vehicles, and more particularly relates to systems and methods for detecting and mapping roadway-interfering objects, such as construction-related objects, in an autonomous vehicle.

### BACKGROUND

An autonomous vehicle is a vehicle that is capable of sensing its environment and navigating with little or no user input. It does so by using sensing devices such as radar, lidar, image sensors, and the like. Autonomous vehicles further use information from global positioning systems (GPS) technology, navigation systems, vehicle-to-vehicle communication, vehicle-to-infrastructure technology, and/or drive-by-wire systems to navigate the vehicle.

While recent years have seen significant advancements in navigation systems, such systems might still be improved in a number of respects. For example, autonomous vehicles often encounter previously unknown road construction zones along a route to a planned destination. It would be advantageous to detect and map the presence of roadway-interfering objects to assist in, among other things, path planning.

Accordingly, it is desirable to provide systems and methods for detecting and mapping roadway-interfering objects in autonomous vehicles. Furthermore, other desirable features and characteristics of the present invention will become apparent from the subsequent detailed description and the appended claims, taken in conjunction with the accompanying drawings and the foregoing technical field and background.

### SUMMARY

Systems and method are provided for controlling a first vehicle. In one embodiment, a construction zone mapping method includes receiving sensor data relating to an environment associated with a vehicle, determining that a roadway-interfering object is present within the environment based on the sensor data, and generating a composite map including a representation of the roadway-interfering object superimposed upon a defined map of the environment.

In one embodiment, the method includes transmitting information related to the roadway-interfering object over a network to a server such that the information related to the roadway-interfering object is available over the network to a second vehicle configured to determine that the roadway-interfering object is present within the environment.

In one embodiment, determining that the roadway-interfering object is present within the environment includes processing the sensor data via a convolutional neural network model.

In one embodiment, the roadway-interfering object is present within the environment includes determining the presence of at least one of: a traffic cone, a traffic barrier, a traffic barrel, a construction sign, a reflective vest, a construction helmet, an arrow-board trailer, and a piece of construction equipment.

In one embodiment, the method includes determining a position of the roadway-interfering object based on lidar sensor data.

In one embodiment, the method includes generating a hot-spot plot corresponding to a spatial likelihood of the presence of the roadway-interfering object, and generating the composite map based on the hot-spot plot.

In one embodiment, the method includes using a homographic projection of roadway-interfering object onto a ground plane to determine a position of the roadway-interfering object.

A system for controlling a vehicle in accordance with one embodiment includes a roadway-interfering object recognition module and a roadway-interfering object mapping module. The roadway-interfering object recognition module, including a processor, configured to receive sensor data relating to an environment associated with the vehicle and determine that a roadway-interfering object is present within the environment based on the sensor data. The roadway-interfering object mapping module is configured to generate a composite map including a representation of the roadway-interfering object superimposed upon a defined map of the environment.

In one embodiment, the roadway-interfering object mapping module transmits information related to the roadway-interfering object over a network to a server.

In one embodiment, the roadway-interfering object recognition module is configured to determine that the roadway-interfering object is present within the environment by processing the sensor data via a convolutional neural network model.

In one embodiment, the roadway-interfering object is at least one of a traffic cone, a traffic barrier, a traffic barrel, a construction sign, a reflective vest, a construction helmet, an arrow-board trailer, and a piece of construction equipment.

In one embodiment, the roadway-interfering object mapping module determines a position of the roadway-interfering object based on lidar sensor data.

In one embodiment, the roadway-interfering object mapping module is configured to generate a hot-spot plot corresponding to a spatial likelihood of the presence of the roadway-interfering object, and to generate the composite map based on the hot-spot plot.

In one embodiment, the roadway-interfering object mapping module is configured to use a homographic projection of roadway-interfering object onto a ground plane to determine a position of the roadway-interfering object.

In one embodiment, the roadway-interfering object mapping module is configured to transmit information related to the roadway-interfering object over a network to a server.

An autonomous vehicle in accordance with one embodiment includes at least one sensor that provides sensor data; and a controller that, by a processor and based on the sensor data: receives sensor data relating to an environment associated with a vehicle; determines that a roadway-interfering object is present within the environment based on the sensor data; and generates a composite map including a representation of the roadway-interfering object superimposed upon a defined map of the environment.

In one embodiment, the controller implements a convolutional neural network model.

In one embodiment, the at least one sensor includes at least one of an optical sensor and a lidar sensor.

In one embodiment, the roadway-interfering object includes a traffic cone, a traffic barrier, a traffic barrel, a construction sign, a reflective vest, a construction helmet, an arrow-board trailer, or a piece of construction equipment.

In one embodiment, the controller is configured to generate a hot-spot plot corresponding to a spatial likelihood of the presence of the roadway-interfering object, and to generate the composite map based on the hot-spot plot.

### DESCRIPTION OF THE DRAWINGS

The exemplary embodiments will hereinafter be described in conjunction with the following drawing figures, wherein like numerals denote like elements, and wherein:

FIG. 1 is a functional block diagram illustrating an autonomous vehicle including a construction zone mapping system, in accordance with various embodiments;

FIG. 2 is a functional block diagram illustrating a transportation system having one or more autonomous vehicles as shown in FIG. 1, in accordance with various embodiments;

FIG. 3 is functional block diagram illustrating an autonomous driving system (ADS) associated with an autonomous vehicle, in accordance with various embodiments;

FIG. 4 is a top-down, conceptual view of a roadway and construction zone, in accordance with various embodiments;

FIG. 5 presents example roadway-interfering objects and indicia related to a construction zone, in accordance with various embodiments;

FIG. 6 illustrates an exemplary autonomous vehicle determining the location of a construction related object, in accordance with various embodiments;

FIG. 7 illustrates a front-facing camera view of a construction zone, in accordance with various embodiments;

FIG. 8 illustrates a roadway-interfering hot-spot image corresponding to the scenario depicted in FIG. 7, in accordance with various embodiments;

FIG. 9 illustrates a roadway map with superimposed roadway-interfering objects, in accordance with one embodiment;

FIG. 10 is a dataflow diagram illustrating a construction zone mapping system of an autonomous vehicle, in accordance with various embodiments;

FIG. 11 is a flowchart illustrating a control method for controlling the autonomous vehicle, in accordance with various embodiments; and

FIG. 12 is a block diagram of an exemplary convolutional neural network in, accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary, or the following detailed description. As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, machine learning models, radar, lidar, image analysis, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

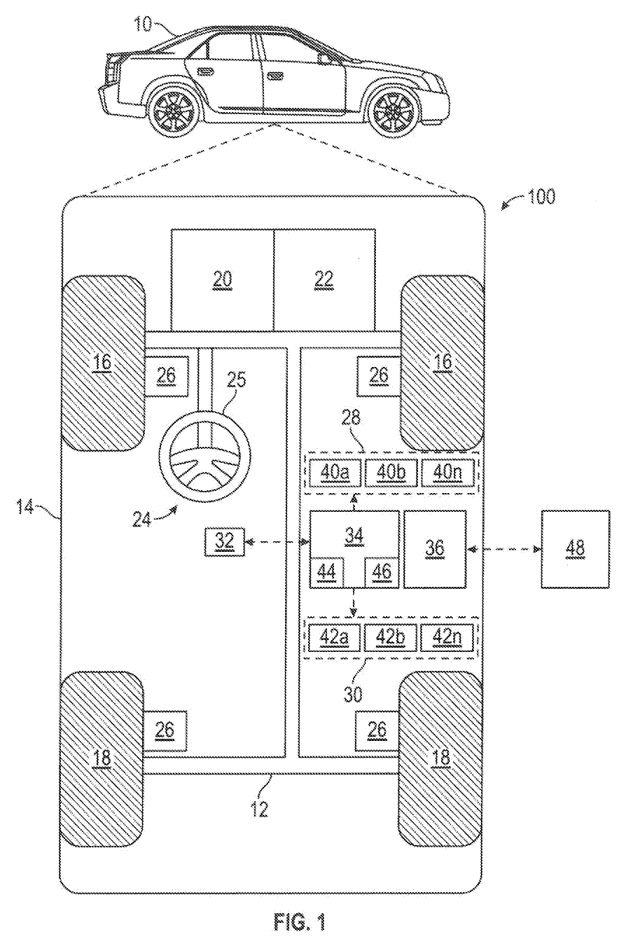

With reference to FIG. 1, a construction zone mapping system shown generally as 100 is associated with a vehicle 10 in accordance with various embodiments. In general, construction zone mapping system (or simply “system”) 100 allows for detecting and mapping the presence of roadway-interfering objects, such as construction-related objects, in the vicinity of AV 10.

As depicted in FIG. 1, the vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

In various embodiments, the vehicle 10 is an autonomous vehicle and the construction zone mapping system 100 is incorporated into the autonomous vehicle 10 (hereinafter referred to as the autonomous vehicle 10). The autonomous vehicle 10 is, for example, a vehicle that is automatically controlled to carry passengers from one location to another. The vehicle 10 is depicted in the illustrated embodiment as a passenger car, but it should be appreciated that any other vehicle, including motorcycles, trucks, sport utility vehicles (SUVs), recreational vehicles (RVs), marine vessels, aircraft, etc., can also be used.

In an exemplary embodiment, the autonomous vehicle 10 corresponds to a level four or level five automation system under the Society of Automotive Engineers (SAE) “J3016” standard taxonomy of automated driving levels. Using this terminology, a level four system indicates “high automation,” referring to a driving mode in which the automated driving system performs all aspects of the dynamic driving task, even if a human driver does not respond appropriately to a request to intervene. A level five system, on the other hand, indicates “full automation,” referring to a driving mode in which the automated driving system performs all aspects of the dynamic driving task under all roadway and environmental conditions that can be managed by a human driver. It will be appreciated, however, the embodiments in accordance with the present subject matter are not limited to any particular taxonomy or rubric of automation categories. Furthermore, systems in accordance with the present embodiment may be used in conjunction with any vehicle in which the present subject matter may be implemented, regardless of its level of autonomy.

As shown, the autonomous vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16 and 18 according to selectable speed ratios. According to various embodiments, the transmission system 22 may include a step-ratio automatic transmission, a continuously-variable transmission, or other appropriate transmission.

The brake system 26 is configured to provide braking torque to the vehicle wheels 16 and 18. Brake system 26 may, in various embodiments, include friction brakes, brake by wire, a regenerative braking system such as an electric machine, and/or other appropriate braking systems.

The steering system 24 influences a position of the vehicle wheels 16 and/or 18. While depicted as including a steering wheel 25 for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 10 (such as the state of one or more occupants). Sensing devices 40a-40n might include, but are not limited to, radars (e.g., long-range, medium-range-short range), lidars, global positioning systems, optical cameras (e.g., forward facing, 360-degree, rear-facing, side-facing, stereo, etc.), thermal (e.g., infrared) cameras, ultrasonic sensors, odometry sensors (e.g., encoders) and/or other sensors that might be utilized in connection with systems and methods in accordance with the present subject matter.

The actuator system 30 includes one or more actuator devices 42a-42n that control one or more vehicle features such as, but not limited to, the propulsion system 20, the transmission system 22, the steering system 24, and the brake system 26. In various embodiments, autonomous vehicle 10 may also include interior and/or exterior vehicle features not illustrated in FIG. 1, such as various doors, a trunk, and cabin features such as air, music, lighting, touch-screen display components (such as those used in connection with navigation systems), and the like.

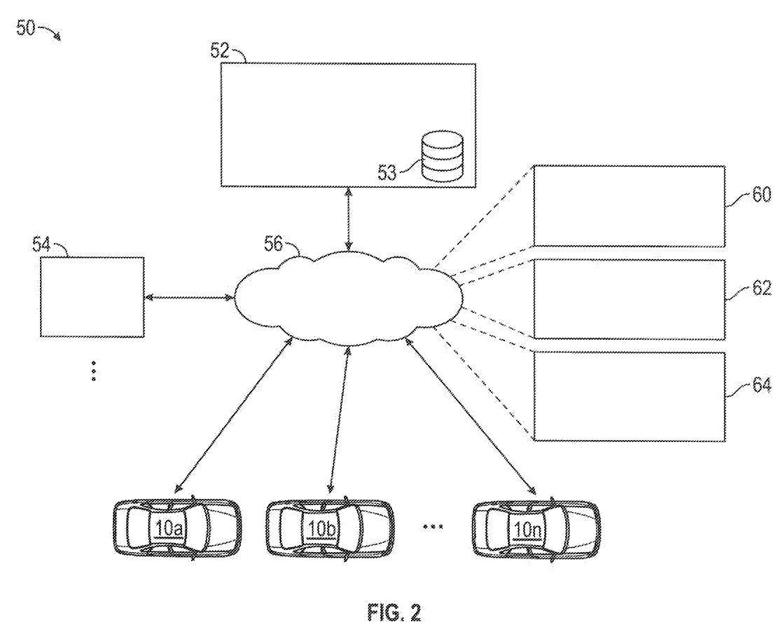

The data storage device 32 stores data for use in automatically controlling the autonomous vehicle 10. In various embodiments, the data storage device 32 stores defined maps of the navigable environment. In various embodiments, the defined maps may be predefined by and obtained from a remote system (described in further detail with regard to FIG. 2). For example, the defined maps may be assembled by the remote system and communicated to the autonomous vehicle 10 (wirelessly and/or in a wired manner) and stored in the data storage device 32. Route information may also be stored within data storage device 32—i.e., a set of road segments (associated geographically with one or more of the defined maps) that together define a route that the user may take to travel from a start location (e.g., the user's current location) to a target location. As will be appreciated, the data storage device 32 may be part of the controller 34, separate from the controller 34, or part of the controller 34 and part of a separate system.

The controller 34 includes at least one processor 44 and a computer-readable storage device or media 46. The processor 44 may be any custom-made or commercially available processor, a central processing unit (CPU), a graphics processing unit (GPU), an application specific integrated circuit (ASIC) (e.g., a custom ASIC implementing a neural network), a field programmable gate array (FPGA), an auxiliary processor among several processors associated with the controller 34, a semiconductor-based microprocessor (in the form of a microchip or chip set), any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10. In various embodiments, controller 34 is configured to implement a roadway-interfering object mapping system as discussed in detail below.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals that are transmitted to the actuator system 30 to automatically control the components of the autonomous vehicle 10 based on the logic, calculations, methods, and/or algorithms. Although only one controller 34 is shown in FIG. 1, embodiments of the autonomous vehicle 10 may include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10.

The communication system 36 is configured to wirelessly communicate information to and from other entities 48, such as but not limited to, other vehicles (“V2V” communication), infrastructure (“V2I” communication), networks (“V2N” communication), pedestrian (“V2P” communication), remote transportation systems, and/or user devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

With reference now to FIG. 2, in various embodiments, the autonomous vehicle 10 described with regard to FIG. 1 may be suitable for use in the context of a taxi or shuttle system in a certain geographical area (e.g., a city, a school or business campus, a shopping center, an amusement park, an event center, or the like) or may simply be managed by a remote system. For example, the autonomous vehicle 10 may be associated with an autonomous-vehicle-based remote transportation system. FIG. 2 illustrates an exemplary embodiment of an operating environment shown generally at 50 that includes an autonomous-vehicle-based remote transportation system (or simply “remote transportation system”) 52 that is associated with one or more autonomous vehicles 10a-10n as described with regard to FIG. 1. In various embodiments, the operating environment 50 (all or a part of which may correspond to entities 48 shown in FIG. 1) further includes one or more user devices 54 that communicate with the autonomous vehicle 10 and/or the remote transportation system 52 via a communication network 56.

The communication network 56 supports communication as needed between devices, systems, and components supported by the operating environment 50 (e.g., via tangible communication links and/or wireless communication links). For example, the communication network 56 may include a wireless carrier system 60 such as a cellular telephone system that includes a plurality of cell towers (not shown), one or more mobile switching centers (MSCs) (not shown), as well as any other networking components required to connect the wireless carrier system 60 with a land communications system. Each cell tower includes sending and receiving antennas and a base station, with the base stations from different cell towers being connected to the MSC either directly or via intermediary equipment such as a base station controller. The wireless carrier system 60 can implement any suitable communications technology, including for example, digital technologies such as CDMA (e.g., CDMA2000), LTE (e.g., 4G LTE or 5G LTE), GSM/GPRS, or other current or emerging wireless technologies. Other cell tower/base station/MSC arrangements are possible and could be used with the wireless carrier system 60. For example, the base station and cell tower could be co-located at the same site or they could be remotely located from one another, each base station could be responsible for a single cell tower or a single base station could service various cell towers, or various base stations could be coupled to a single MSC, to name but a few of the possible arrangements.

Apart from including the wireless carrier system 60, a second wireless carrier system in the form of a satellite communication system 64 can be included to provide uni-directional or bi-directional communication with the autonomous vehicles 10a-10n. This can be done using one or more communication satellites (not shown) and an uplink transmitting station (not shown). Uni-directional communication can include, for example, satellite radio services, wherein programming content (news, music, etc.) is received by the transmitting station, packaged for upload, and then sent to the satellite, which broadcasts the programming to subscribers. Bi-directional communication can include, for example, satellite telephony services using the satellite to relay telephone communications between the vehicle 10 and the station. The satellite telephony can be utilized either in addition to or in lieu of the wireless carrier system 60.

A land communication system 62 may further be included that is a conventional land-based telecommunications network connected to one or more landline telephones and connects the wireless carrier system 60 to the remote transportation system 52. For example, the land communication system 62 may include a public switched telephone network (PSTN) such as that used to provide hardwired telephony, packet-switched data communications, and the Internet infrastructure. One or more segments of the land communication system 62 can be implemented through the use of a standard wired network, a fiber or other optical network, a cable network, power lines, other wireless networks such as wireless local area networks (WLANs), or networks providing broadband wireless access (BWA), or any combination thereof. Furthermore, the remote transportation system 52 need not be connected via the land communication system 62, but can include wireless telephony equipment so that it can communicate directly with a wireless network, such as the wireless carrier system 60.

Although only one user device 54 is shown in FIG. 2, embodiments of the operating environment 50 can support any number of user devices 54, including multiple user devices 54 owned, operated, or otherwise used by one person. Each user device 54 supported by the operating environment 50 may be implemented using any suitable hardware platform. In this regard, the user device 54 can be realized in any common form factor including, but not limited to: a desktop computer; a mobile computer (e.g., a tablet computer, a laptop computer, or a netbook computer); a smartphone; a video game device; a digital media player; a component of a home entertainment equipment; a digital camera or video camera; a wearable computing device (e.g., smart watch, smart glasses, smart clothing); or the like. Each user device 54 supported by the operating environment 50 is realized as a computer-implemented or computer-based device having the hardware, software, firmware, and/or processing logic needed to carry out the various techniques and methodologies described herein. For example, the user device 54 includes a microprocessor in the form of a programmable device that includes one or more instructions stored in an internal memory structure and applied to receive binary input to create binary output. In some embodiments, the user device 54 includes a GPS module capable of receiving GPS satellite signals and generating GPS coordinates based on those signals. In other embodiments, the user device 54 includes cellular communications functionality such that the device carries out voice and/or data communications over the communication network 56 using one or more cellular communications protocols, as are discussed herein. In various embodiments, the user device 54 includes a visual display, such as a touch-screen graphical display, or other display.

The remote transportation system 52 includes one or more backend server systems, not shown), which may be cloud-based, network-based, or resident at the particular campus or geographical location serviced by the remote transportation system 52. The remote transportation system 52 can be manned by a live advisor, an automated advisor, an artificial intelligence system, or a combination thereof. The remote transportation system 52 can communicate with the user devices 54 and the autonomous vehicles 10a-10n to schedule rides, dispatch autonomous vehicles 10a-10n, and the like. In various embodiments, the remote transportation system 52 stores store account information such as subscriber authentication information, vehicle identifiers, profile records, biometric data, behavioral patterns, and other pertinent subscriber information.

In accordance with a typical use case workflow, a registered user of the remote transportation system 52 can create a ride request via the user device 54. The ride request will typically indicate the passenger's desired pickup location (or current GPS location), the desired destination location (which may identify a predefined vehicle stop and/or a user-specified passenger destination), and a pickup time. The remote transportation system 52 receives the ride request, processes the request, and dispatches a selected one of the autonomous vehicles 10a-10n (when and if one is available) to pick up the passenger at the designated pickup location and at the appropriate time. The transportation system 52 can also generate and send a suitably configured confirmation message or notification to the user device 54, to let the passenger know that a vehicle is on the way.

As can be appreciated, the subject matter disclosed herein provides certain enhanced features and functionality to what may be considered as a standard or baseline autonomous vehicle 10 and/or an autonomous vehicle based remote transportation system 52. To this end, an autonomous vehicle and autonomous vehicle based remote transportation system can be modified, enhanced, or otherwise supplemented to provide the additional features described in more detail below.

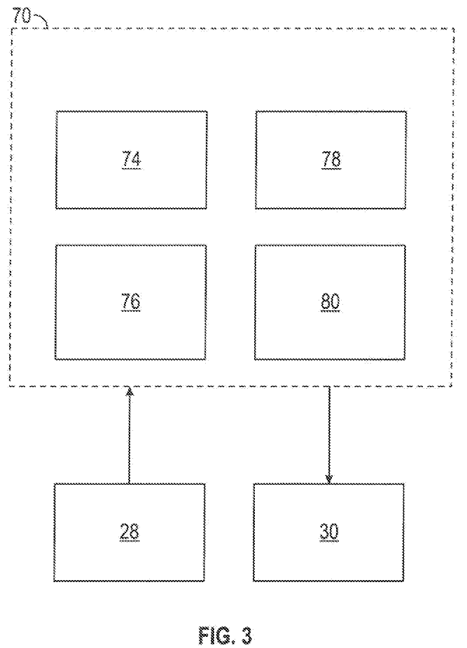

In accordance with various embodiments, controller 34 implements an autonomous driving system (ADS) 70 as shown in FIG. 3. That is, suitable software and/or hardware components of controller 34 (e.g., processor 44 and computer-readable storage device 46) are utilized to provide an autonomous driving system 70 that is used in conjunction with vehicle 10.

In various embodiments, the instructions of the autonomous driving system 70 may be organized by function or system. For example, as shown in FIG. 3, the autonomous driving system 70 can include a computer vision system 74, a positioning system 76, a guidance system 78, and a vehicle control system 80. As can be appreciated, in various embodiments, the instructions may be organized into any number of systems (e.g., combined, further partitioned, etc.) as the disclosure is not limited to the present examples.

In various embodiments, the computer vision system 74 synthesizes and processes sensor data and predicts the presence, location, classification, and/or path of objects and features of the environment of the vehicle 10. In various embodiments, the computer vision system 74 can incorporate information from multiple sensors (e.g., sensor system 28), including but not limited to cameras, lidars, radars, and/or any number of other types of sensors.

The positioning system 76 processes sensor data along with other data to determine a position (e.g., a local position relative to a map, an exact position relative to a lane of a road, a vehicle heading, etc.) of the vehicle 10 relative to the environment. As can be appreciated, a variety of techniques may be employed to accomplish this localization, including, for example, simultaneous localization and mapping (SLAM), particle filters, Kalman filters, Bayesian filters, and the like.

The guidance system 78 processes sensor data along with other data to determine a path for the vehicle 10 to follow. The vehicle control system 80 generates control signals for controlling the vehicle 10 according to the determined path.

In various embodiments, the controller 34 implements machine learning techniques to assist the functionality of the controller 34, such as feature detection/classification, obstruction mitigation, route traversal, mapping, sensor integration, ground-truth determination, and the like.

In various embodiments, all or parts of the obstacle management system 100 may be included within the computer vision system 74, the positioning system 76, the guidance system 78, and/or the vehicle control system 80. As mentioned briefly above, the system 100 of FIG. 1 is configured to determine the presence of one or more roadway-interfering objects in the vicinity of AV 10 (e.g., traffic cones, signs, barricades, landscaping equipment, or any other object that may impede or otherwise affect the flow of nearby traffic), and generate a composite map including a representation of the roadway-interfering objects superimposed upon a defined map of the environment—e.g., a map stored within data storage device 32 of FIG. 1.

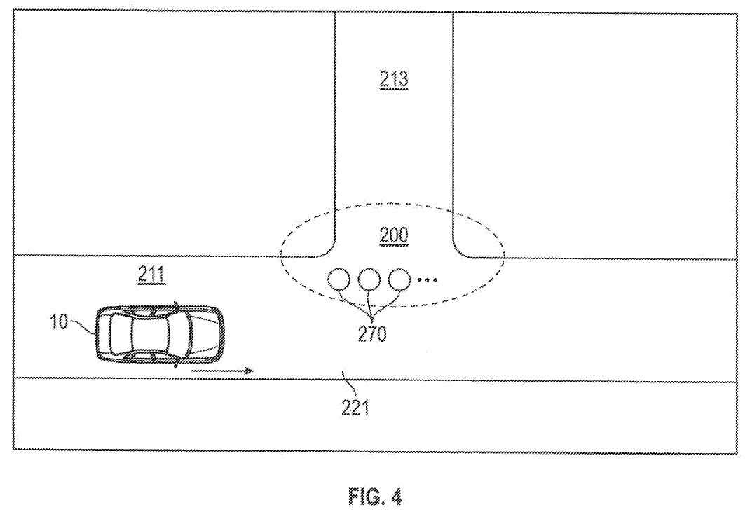

In that regard, FIG. 4 presents a top-down view of an example scenario useful in understanding the present subject matter. As illustrated, a vehicle 10 is shown traveling along a roadway 221 and encountering (via its various sensing devices) a road construction zone 200 (e.g., blocking access to a roadway 213). In accordance with various embodiments, construction zone mapping system 100 detects and classifies one or more roadway-interfering objects 270 within construction zone 200, and then generates a composite map including a representation of the roadway-interfering objects 270 superimposed upon a defined map (e.g., of roadways 213 and 221, as shown).

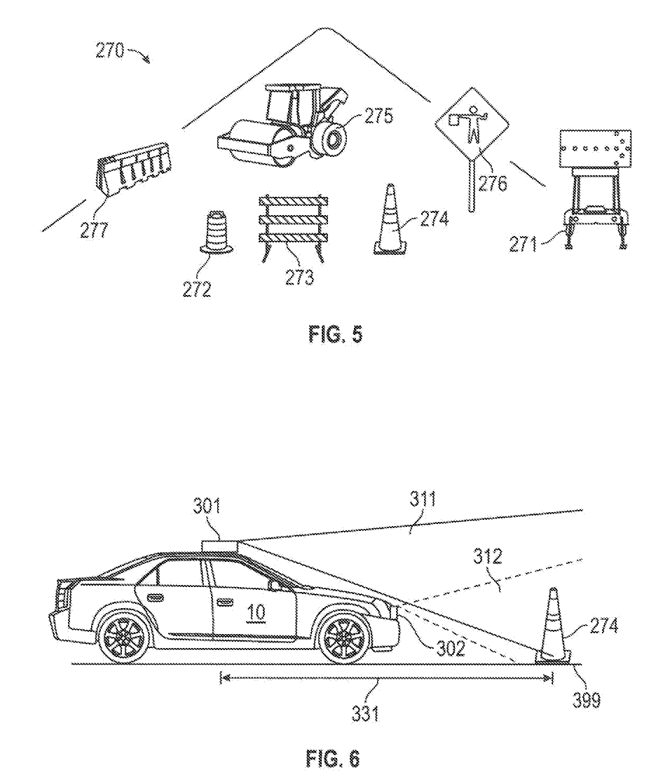

FIG. 5 depicts just a few examples of possible roadway-interfering objects 270 that might be recognized by construction zone mapping system 100, namely, one or more traffic cones 274, one or more traffic barriers 273, one or more traffic barrels 272, signage typically associated with construction, such as a temporary or hand-held construction sign 276, road construction equipment 275, and/or one or more arrow board trailers 271. It will be understood that the objects, artifacts, text, graphical features, and iconography depicted in FIG. 5 are not intended to be limiting. Based on the context (e.g., the country in which vehicle 10 is operating) the nature of the roadway-interfering objects 270 may vary.

Further in accordance with various embodiments, construction zone mapping system 100 determines the spatial position of roadway-interfering objects 270 relative to AV 10 and/or in terms of an absolute coordinate system. Referring to FIG. 6, for example, AV 10 may use a top-mounted sensing device 301 (e.g., a lidar sensor or a 360-degree camera) having a field of view 311 allowing system 100 to determine the distance 331 from AV 10 to a traffic cone 274. Similarly, AV 10 may use a front-mounted sensor 302 having a field of view 312 to determine distance 331. In some embodiments, estimates of distance 331 from different sensors 301, 302 are reconciled or otherwise combined to arrive at a more accurate estimate of distance 331. That is, in cases where multiple sensors produce differing estimates of distance 331, a calculation may be performed by system 100 to arrive at a single distance value. For example, a simple average of the various distance estimates may be used. In other embodiments, a weighted average based on the accuracy of the sensors may be used—i.e., the estimate determined by a lidar sensor may be weighted more heavily than that of a lower-accuracy radar sensor.

While distance 331 is illustrated as extending from an approximate midsection of AV 10, the range of embodiments is not intended to be limiting. Any convenient reference point or points may be used to characterize the position of roadway-interfering object 274. For example, in some embodiments the position is expressed in terms of a distance from the frontmost portion (e.g., a front bumper) of AV 10. This distance may be calculated in a variety of ways. For example, calibration settings for the various sensors (e.g., 301, 302) stored within a subsystem of AV 10 may include three-dimensional coordinate values (e.g., a transformation vector) that specifies the locations and orientations of sensors 301, 302 as well as geometric features of AV 10 (such as the length, height, width, wheelbase, etc.).

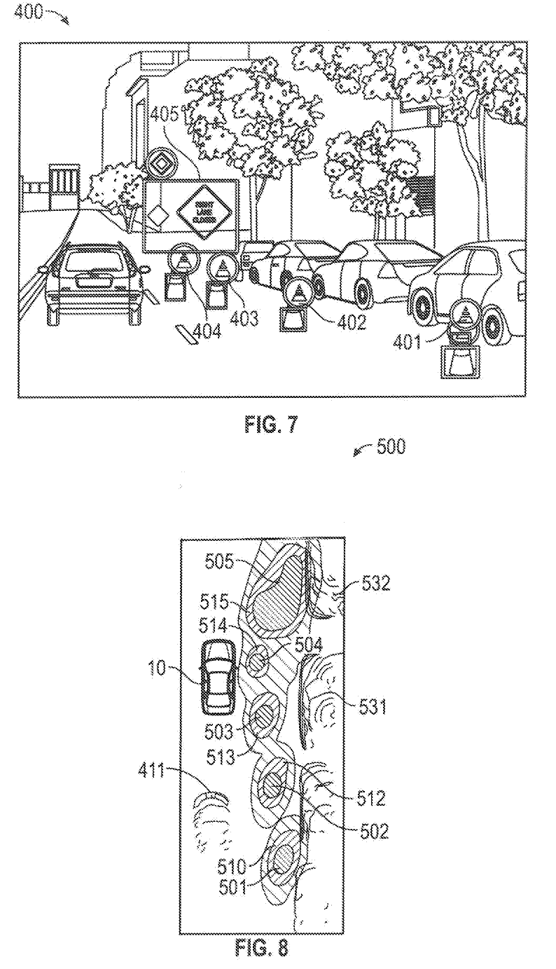

In some embodiments, as described in further detail below, a hot-spot plot corresponding to a spatial likelihood of the presence of the roadway-interfering object is generated in order to assist in path planning and creation of the composite map. Such an embodiment is illustrated in FIGS. 7-9.

More particularly, FIG. 7 illustrates, from the point of view of an example autonomous vehicle, an “out-the-window view” 400 (i.e., the view that might typically be observed through a vehicle's front windshield) of a roadway lined by a number of detected roadway-interfering objects that may together define, in the general sense, a “construction zone.” Specifically, four traffic cones 401, 402, 403, and 404 have been detected and classified in a lane to the right, along with a traffic control sign 405.

Each of the objects 401-405 are also shown in FIG. 7 with corresponding bounding rectangles and icons related to their respective identities, indicating the way in which information regarding objects 401-405 might be represented by AV 10 upon encountering those objects 401-405. As is known in the art, a “bounding rectangle” is a geometric shape (either three-dimensional or two-dimensional) that encloses a detected object to provide a simplified representation of that object, thereby reducing the computational complexity of any calculations performed by the system with respect to the object. Thus, in FIG. 7, two dimensional rectangular regions are shown encompassing each of the detected roadway cones (i.e., 401-404). Further, “cone” icons are illustrated spatially proximate to each of the objects. It will be appreciated that the range of possible bounding geometries and icons are not limited in any way by the example shown in FIG. 7.

FIG. 8 presents a top-down view 500 of the scene 400 depicted at FIG. 7 at a subsequent time (i.e., after AV 10 has moved forward to some extent), and includes a hot-spot plot, as discussed below, along with groups of sensor returns (e.g., lidar sensor returns) associated with various objects in the environment. The subject AV 10 is shown in FIG. 8 traveling in front of another vehicle 411 (illustrated by its characteristic lidar returns) alongside a number of parked cars 531, 532, etc., each also visible in FIG. 7.

The hot-spot component of FIG. 8 is shown as shaded regions whose relative darkness (in this illustration) is proportional to the percentage likelihood that a roadway-interfering object is located at that location. Such a hot-spot plot might be generated, for example, by using the determined position and classification of individual roadway-interfering objects, assigning a very high (e.g., 90% probability) to those points, then assigning a gradually decreasing probability (e.g., via a Gaussian distance) to an area around each of those points.

In one embodiment, the hot-spots are generated using a mixture of exponential distributions technique, wherein each type of detection may generate a different distribution shape. That is, the shape of the distribution will generally correspond to the shape of the object—particularly with respect to how defined the “edges” of the object are as well as the overall size (width, height, length) of the object relative to the sensors used for detection. For example, large traffic sign might generate detections (i.e., distribution shapes) in which the hot-spot falls off quickly around the edges, due to the well-defined geometrical features of such signs. Likewise, traffic cones will also typically generate very sharp Gaussian detections. In contrast, large barricade components with soft edges and the like might generate relatively “soft” distribution shapes.

In some embodiments, the “uncertainty” of the detection is reduced over time as the detected object remains in the field of view of the sensors. Thus, when something blocks the detected object temporarily, such as a truck driving by, the system detects the presence of the truck and stops decaying the occluded detections (i.e., the uncertainty remains unchanged). Additionally, when the detected object leaves the sensor's view, it may stop decaying, so once the car drives by a construction site it may stop updating its information, but may remember what it saw to affect prediction and planning for cars that are likely to encounter the same objects—e.g., another vehicle approaching from behind AV 10.

By way of example, as shown in FIGS. 7 and 8, a hot-spot region 501 (with a high probability) is assigned to traffic cone 401, while a lower probability elliptical or circular region 510 extends within a meter or so of traffic cone 401. Similarly, regions 502 and 512 spatially correlate to traffic cone 402, regions 503 and 513 spatially correlate to traffic cone 403, and regions 504 and 514 spatially correlate to traffic cone 404. Similarly, a large high-probability region is illustrated by the hot spot regions 505 and 515 correlating to traffic sign structure 405.

FIG. 9 shows an exemplary top-view composite map 600 including a previously determined map (i.e., showing a roadway 610, as may be produced by the route guidance system or other subsystem of AV 10) with superimposed roadway-interfering objects depicted by icons 601-605. In some embodiments, the locations of objects in FIG. 9 are selected to correspond to the peaks of the various hotspots (local maxima) shown in FIG. 8.

In the illustrated embodiment, icons 601-604 correspond, respectively, to traffic cones 401-404, and icon 605 corresponds to traffic sign structure 405. It will be appreciated that composite map 600 may be displayed for an occupant (e.g., by a media system of the vehicle) or a remote assistance advisor, or merely represented internally by construction zone mapping system 100. In some embodiments, as shown in FIG. 9, the icons used to represent roadway-interfering objects in map 600 may correspond roughly to the size and shape of those items as they might appear from above. Thus, for example, icons 601-605 are circular (the top view of a cone), and icon 605 is a thin rectangular icon similar to the top view of a road sign.

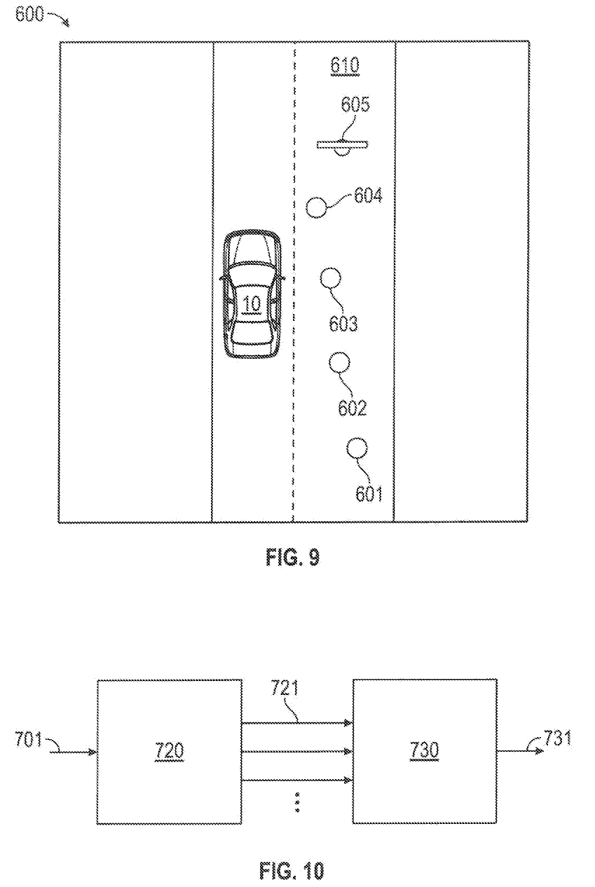

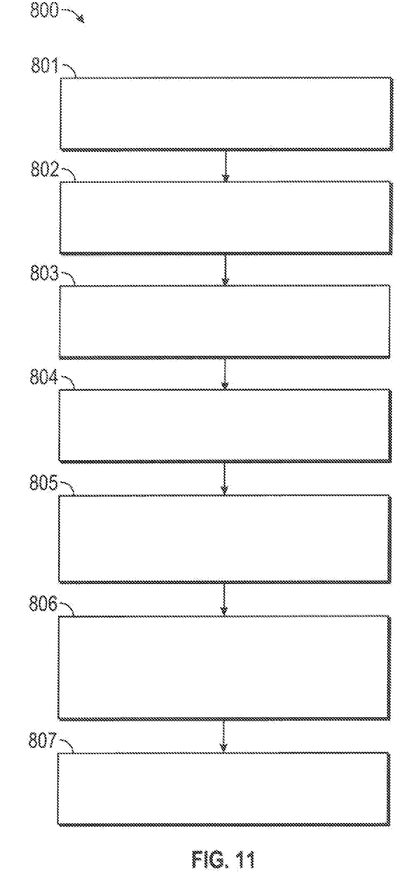

Referring now to FIG. 10, with continued reference to FIGS. 1-3, an exemplary construction zone mapping system 100 may include a roadway-interfering object recognition module (or simply “recognition module” 720) and a construction related object mapping module 730. Roadway-interfering object recognition module 720 receives sensor data 701 relating to the vehicle's environment (e.g., camera images, lidar data, or any other sensor data received from sensors 28 (FIG. 1)) and has, as its output, an indication as to the presence of roadway-interfering objects in the environment (illustrated as a set of outputs 721). A graphical example of output 721 is illustrated in FIG. 8, as described above.

Roadway-interfering object mapping module 730 receives the outputs 721 (e.g., information regarding the number and types of construction related objects observed). Roadway-interfering object mapping module 730 processes the outputs 721 to produce an output 731 corresponding to a composite map or sufficient data to generate such a composite map including a representation of the roadway-interfering objects superimposed on a defined map of the environment. A graphical example of such an output 731 is illustrated in FIG. 9, as described above.

It will be understood that various embodiments of the construction zone mapping system 100 according to the present disclosure may include any number of sub-modules embedded within the controller 34 which may be combined and/or further partitioned to similarly implement systems and methods described herein. Furthermore, inputs to the construction zone mapping system 100 may be received from the sensor system 28, received from other control modules (not shown) associated with the autonomous vehicle 10, received from the communication system 36, and/or determined/modeled by other sub-modules (not shown) within the controller 34. Furthermore, the inputs might also be subjected to preprocessing, such as sub-sampling, noise-reduction, normalization, feature-extraction, missing data reduction, and the like.

Furthermore, the various modules described above (e.g., modules 720 and/or 730) may be implemented as one or more machine learning models that undergo supervised, unsupervised, semi-supervised, or reinforcement learning and perform classification (e.g., binary or multiclass classification), regression, clustering, dimensionality reduction, and/or such tasks. Examples of such models include, without limitation, artificial neural networks (ANN) (such as a recurrent neural networks (RNN) and convolutional neural network (CNN)), decision tree models (such as classification and regression trees (CART)), ensemble learning models (such as boosting, bootstrapped aggregation, gradient boosting machines, and random forests), Bayesian network models (e.g., naive Bayes), principal component analysis (PCA), support vector machines (SVM), clustering models (such as K-nearest-neighbor, K-means, expectation maximization, hierarchical clustering, etc.), linear discriminant analysis models. In some embodiments, training occurs within a system remote from vehicle 10 (e.g., system 52 in FIG. 2) and is subsequently downloaded to vehicle 10 for use during normal operation of vehicle 10. In other embodiments, training occurs at least in part within controller 34 of vehicle 10, itself, and the model is subsequently shared with external systems and/or other vehicles in a fleet (such as depicted in FIG. 2). Training data may similarly be generated by vehicle 10 or acquired externally, and may be partitioned into training sets, validation sets, and test sets prior to training.

Referring now to FIG. 11, and with continued reference to FIGS. 1-10, the illustrated flowchart provides a control method 800 that can be performed by construction zone mapping system 100 in accordance with the present disclosure. As can be appreciated in light of the disclosure, the order of operation within the method is not limited to the sequential execution as illustrated in the figure, but may be performed in one or more varying orders as applicable and in accordance with the present disclosure. In various embodiments, the method can be scheduled to run based on one or more predetermined events, and/or can run continuously during operation of autonomous vehicle 10.

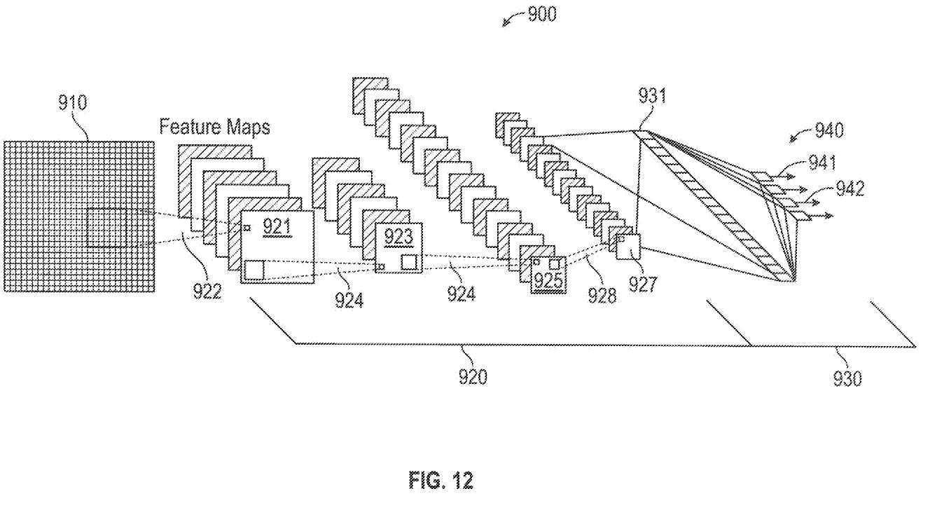

In various embodiments, the method 800 begins at 801, in which roadway-interfering object recognition module 720 is suitably trained to detect and identify objects, such as roadway-interfering objects. This training may be performed via a variety of supervised or unsupervised machine learning techniques. In various embodiments, module 720 implements an artificial neural network (ANN) that is trained via supervised learning by presenting it with a training set comprising a number of images of known roadway-interfering objects. In one embodiment, module 720 implements a convolutional neural network (CNN) as described in further detail below in connection with FIG. 12.

With continued reference to FIG. 11, during normal operation the vehicle 10 receives (at 802) sensor data relating to the vehicle's environment. In connection with the illustrated embodiment, the sensor data generally includes optical image data (such as that received from a camera) but might also include lidar data and the like. That is, while optical image data might be particularly useful in detecting construction related objects 270, lidar sensors might also be used to determine the range of such objects relative to vehicle 10 (e.g., based on point-cloud imaging).

Next, at 803, module 720 determines the presence of roadway-interfering objects (such as objects 270) in the environment. In various embodiments, for example, the sensor data is applied to a previously trained CNN that produces one or more outputs indicative of the presence of objects 270. For example, outputs 303 might include real number values indicative of the probability that such an object has been recognized in the scene (e.g., traffic cone:0.87, construction equipment:0.2, etc.). These outputs will generally be produced by applying the trained weights of each of the various layers to the input image, as illustrated in FIG. 12. It will be appreciated that output 721 might take a variety of forms depending upon the particular machine learning technique implemented by module 720.

Next, at 804, module 730 determines the position (e.g., relative or absolute) of the detected roadway-interfering objects. In one embodiment, a homographic projection of the roadway-interfering objects are “projected” (by module 730) onto a ground plane (e.g., 399 in FIG. 6) to determine a position of the roadway-interfering object. System 100 may localize the roadway-interfering objects in 3D space by combining distance estimations and ray projection using the extrinsic parameters of the calibrated sensors of sensor system 28.

As used herein, a “homography” or homographic projection refers to a matrix in which, if the system knows the transform from the sensor to the ground plane, it can then transfer the image into a top down perspective of the ground plane. Thus, referring to FIG. 6, module 730 starts with the three-dimensional coordinates of object 274 and determines where that object (or its bounding rectangle, not illustrated in FIG. 6) would intersect the ground plane 399 if it were to be translated (i.e., “projected”) downward toward the ground. In one embodiment, system 100 assumes is that the bottom of the bounding box is substantially coplanar with the ground

At 805, module 730 generates a hot-spot plot corresponding to the spatial likelihood of the roadway-interfering objects. That is, given the determined position of the detected and classified roadway-interfering objects (e.g., objects 401-405 in FIG. 7), a two-dimensional tensor of real-valued probabilities is generated such that relatively high probabilities (e.g., close to 1.0) are assigned to the determined positions of the roadway-interfering objects, and relatively low probabilities (e.g., close to 0.0) are assigned to locations that are a substantial distance from the determined positions of the detected objects (e.g., based on a Gaussian distance metric). In some embodiments, the nature of these distance metrics is based in part on the classification of the roadway-interfering object.

Next, at 806, module 730 generates a composite map that includes a representation of roadway-interfering objects superimposed on a defined map of the environment. As mentioned above, the composite map (e.g., map 600) may be displayed for an occupant (e.g., by a media system of the vehicle), or merely represented internally by construction zone mapping system 100.

Next, at 807, information regarding the detected roadway-interfering objects (e.g., the position and classification of such objects) may be transmitted to an external server, such as server 52. Such information might subsequently be downloaded by other autonomous vehicles.

In accordance with one embodiment, module 720 of FIG. 10 is implemented as a convolutional neural network (CNN). Referring now to FIG. 12, an example CNN 900 generally receives an input image 910 (e.g., an optical image of the environment from sensors 28 of AV 10) and produces a series of outputs 940 associated with whether and to what extent roadway-interfering objects are recognized within the input image 910. In that regard, input 910 will be referred to without loss of generality as an “image,” even though it might in fact include a variety of sensor data types.

In general, CNN 900 includes a feature extraction phase 920 and a classification phase 930. Classification phase 930 includes a convolution 920 that uses an appropriately sized convolutional filter to produce a set of feature maps 921 corresponding to smaller tilings of input image 910. As is known, convolution as a process is translationally invariant—i.e., features of interest (signage, human beings) can be identified regardless of their location within image 910.

Subsampling 924 is then performed on feature maps 921 to produce a set of smaller feature maps 923 that are effectively “smoothed” to reduce sensitivity of the convolutional filters to noise and other variations. Subsampling might involve taking an average or a maximum value over a sample of the inputs 921. Feature maps 923 then undergo another convolution 926 to produce a large set of smaller feature maps 925. Feature maps 925 are then subsampled (928) to produce feature maps 927.

During the classification phase (930), the feature maps 927 are processed to produce a first layer 931, followed by a fully-connected layer 933, from which outputs 940 are produced. Outputs 940 generally include a vector of probabilities associated with objects recognized in input image 910. For example, output 941 might correspond to the likelihood that a traffic cone (e.g., 274 of FIG. 5) has been recognized, output 942 might correspond to the probability that a traffic sign (e.g., 276) has been recognized, and so on.

In general, the CNN 900 illustrated in FIG. 12 may be trained in a supervised mode by presenting it with a large number (i.e., a “corpus”) of labeled (i.e., pre-classified) input images (910) including a range of roadway-interfering objects. Backpropagation is then used to refine the training of CNN 900. The resulting model is then implemented within module 720 of FIG. 10. Subsequently, during normal operation, the trained CNN 900 is used to process images 701 received as AV 10 moves through its environment and observes possible roadway-interfering objects.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A mapping method comprising:
receiving sensor data relating to an environment associated with a vehicle;
determining that a roadway-interfering object is present within the environment based on the sensor data; and
generating, with a processor, a composite map including a representation of the roadway-interfering object superimposed upon a map of the environment.

2. The method of claim 1, further including transmitting information related to the roadway-interfering object over a network to a server.

3. The method of claim 1, wherein determining that the roadway-interfering object is present within the environment includes processing the sensor data via a convolutional neural network model.

4. The method of claim 1, wherein determining that the roadway-interfering object is present within the environment includes determining the presence of a roadway-interfering object.

5. The method of claim 1, further including determining a position of the roadway-interfering object based on lidar sensor data.

6. The method of claim 1, further including generating a hot-spot plot corresponding to a spatial likelihood of the presence of the roadway-interfering object, and generating the composite map based on the hot-spot plot.

7. The method of claim 1, further including using a homographic projection of roadway-interfering object onto a ground plane to determine a position of the roadway-interfering object.

8. A system for controlling a vehicle, comprising:
a roadway-interfering object recognition module, including a processor, configured to receive sensor data relating to an environment associated with the vehicle and determine that a roadway-interfering object is present within the environment based on the sensor data; and
a roadway-interfering object mapping module configured to generate a composite map including a representation of the roadway-interfering object superimposed upon a defined map of the environment.

9. The system of claim 8, wherein the roadway-interfering object mapping module transmits information related to the roadway-interfering object over a network to a server.

10. The system of claim 8, wherein the roadway-interfering object recognition module is configured to determine that the roadway-interfering object is present within the environment by processing the sensor data via a convolutional neural network model.

11. The system of claim 8, wherein the roadway-interfering object is a construction-related object comprising one of a traffic cone, a traffic barrier, a traffic barrel, a construction sign, a reflective vest, a construction helmet, an arrow-board trailer, and a piece of construction equipment.

12. The system of claim 8, wherein the roadway-interfering object mapping module determines a position of the roadway-interfering object based on lidar sensor data.

13. The system of claim 8, wherein the roadway-interfering object mapping module is configured to generate a hot-spot plot corresponding to a spatial likelihood of the presence of the roadway-interfering object, and to generate the composite map based on the hot-spot plot.

14. The system of claim 8, wherein the roadway-interfering object mapping module is configured to use a homographic projection of roadway-interfering object onto a ground plane to determine a position of the roadway-interfering object.

15. The system of claim 8, further including a communication system configured to transmit information related to the roadway-interfering object over a network to a server such that the information related to the roadway-interfering object is available over the network to a second vehicle configured to determine that the roadway-interfering object is present within the environment.

16. An autonomous vehicle, comprising:
at least one sensor that provides sensor data; and
a controller that, by a processor and based on the sensor data:
receives sensor data relating to an environment associated with a vehicle;
determines that a roadway-interfering object is present within the environment based on the sensor data; and
generates a composite map including a representation of the roadway-interfering object superimposed upon a defined map of the environment.

17. The autonomous vehicle of claim 16, wherein the controller implements a convolutional neural network model.

18. The autonomous vehicle of claim 15, wherein the at least one sensor includes at least one of an optical sensor and a lidar sensor.

19. The autonomous vehicle of claim 15, wherein the roadway-interfering object includes at least one construction related object.

20. The autonomous vehicle of claim 15, wherein the controller is configured to generate a hot-spot plot corresponding to a spatial likelihood of the presence of the roadway-interfering object, and to generate the composite map based on the hot-spot plot.
